(19) United States
(12) Patent Application Publication
(10) Pub. No.: US 2012/0094202 A1
(43) Pub. Date: Apr. 19, 2012

(54) DEVICE FOR PRODUCING ELECTRICITY FOR A SUBMARINE COMPRISING A FUEL CELL

(75) Inventor: Sylvain Rethore, Orvault (FR)

(73) Assignee: DCNS, Paris (FR)

(21) Appl. No.: 13/265,475

(22) PCT Filed: Apr. 21, 2010
(86) PCT No.: PCT/FR2010/050764

§ 371 Date: Jan. 4, 2012

(30) Foreign Application Priority Data
Apr. 21, 2009 (FR) 0952602

(51) Int. Cl. H01M 8/04

(52) U.S. Cl. 429/444

(57) ABSTRACT

The invention relates to a submarine comprising a device for producing electricity including a fuel cell, means for feeding oxygen gas, means for feeding hydrogen fuel, and means for discharging the gas effluents, characterized in that the fuel cell (24) is an internal reforming cell operating at a high temperature and pressure (P), the operating pressure being greater than or equal to a submerged pressure (P₀) of the submarine (2), in that the oxygen gas (11) feeding means and the hydrogen fuel feeding means (15, 115) are capable of bringing the oxygen gas and the hydrogen fuel to a pressure adapted to the operating pressure, and in that the effluent (20, 220) discharge means are capable of discharging the effluents outside the submarine during diving.

The invention relates to the field of submarines and more particularly submarines including a device for producing electricity of the type comprising a fuel cell.

Different types of fuel cells are known today.

For use onboard a submarine, it is currently considered to use an onboard hydrogen production system from reforming a hydrocarbon, associated with a fuel cell operating at a low temperature. Document GB 2 250 130 A discloses such a cell operating at a low temperature.

Such an electricity production device presents a number of difficulties, in particular related to the constraints associated with installation in a submarine. Thus, the storage and supply of the oxygenated gas and hydrogenated fuel necessary for the operation of the cell presents difficulties, such as, for example, the implementation of several successive chemical reactors whereof the respective operating parameters are difficult to control.

In particular, the reforming, upstream of the cell, requires the use of a specific catalytic burner able to supply the necessary energy for the reaction. This burner operates by using oxygen. However, the autonomy of a submarine being limited by the quantity of oxygen it can take onboard, the oxygen used by the reforming burner reduces the autonomy of the submarine proportionately.

Furthermore, the start-up time of the device, corresponding to the time needed to establish redox reactions inside the cell, is long.

Lastly, the theoretical powers that one could achieve with such cells remain reduced and, in any case, incompatible with the powers necessary to propel a submarine.

The invention therefore aims to propose a device for producing electricity of the type including a fuel cell intended to equip a submarine and making it possible to offset the aforementioned drawbacks and, in particular, making it possible to obtain high powers, having increased performance in particular in terms of autonomy, while having only a reduced number of component pieces of equipment.

To that end, the invention relates to a submarine including a device for producing electricity comprising a fuel cell, means for feeding oxygenated gas, means for feeding hydrogenated fuel, and means for discharging the gaseous effluents. The submarine is characterized in that the fuel cell is an internal reforming cell operating at a high temperature and pressure, the operating pressure of the cell being greater than or equal to an immersion pressure of the submarine, in that the oxygenated gas feeding means and the hydrogenated fuel feeding means are capable of bringing the oxygenated gas and the hydrogenated fuel to a pressure adapted to the operating pressure so that the oxygenated gas and the hydrogenated fuel are injected directly into the cell, and in that the effluent discharge means are capable of discharging the gaseous effluents outside the submarine during diving.

According to specific embodiments of the invention, the submarine includes one or more of the following features, considered alone or according to all technically possible combinations:
the means for discharging the gaseous effluents include a circuit for discharging the gaseous effluents provided with a pressure regulating valve making it possible to keep the operating pressure above the submersion pressure.
the means for discharging the gaseous effluents also include a downstream burner connected at the input, on the one hand, to a cathode of the fuel cell and, on the other hand, to an anode of the fuel cell, and connected at the output to the pressure regulating valve.
the means for discharging the gaseous effluents also include a device for recovering the thermal energy of the gaseous effluents.
the device for recovering the thermal energy from the gaseous effluents is a secondary circuit including a steam generator, a steam turbine coupled to an alternator, a steam condenser and a recirculation pump, the steam generator being coupled to the circuit for discharging the gaseous effluents.
the means for feeding oxygenated gas include an oxygen tank that can contain pure oxygen in liquid phase.
the means for feeding oxygenated gas include a sprayer able to generate gaseous oxygen to feed the fuel cell, and a pump able to introduce liquid oxygen into the sprayer at a pressure adapted to the operating pressure.
the means for feeding hydrogenated fuel include a hydrocarbon tank and a pump that can introduce hydrogenated fuel into the fuel cell at the operating pressure.
the means for feeding hydrogenated fuel also comprise a downstream burner connected between the pump and the fuel cell, the downstream burner being supplied with fuel by a bridge of the means for feeding oxygenated gas, the downstream burner constituting a system for preheating the hydrogenated fuel.
at least the fuel cell is installed in a pressure-resistant enclosure whereof the internal pressure is kept at the operating pressure of the fuel cell.
the operating pressure of the fuel cell is greater than or equal to 10 bars, and preferably greater than or equal to a maximum immersion pressure of the submarine.

The invention also relates to a device for producing electricity for a submarine, of the type including a fuel cell, means for feeding oxygenated gas, means for feeding hydrogenated fuel and means for discharging gaseous effluents. This device is characterized in that the fuel cell is an internal reforming cell operating at a high temperature and high pressure, the operating pressure of the cell being greater than or equal to an immersion pressure of the submarine, in that the means for feeding oxygenated gas and the means for feeding hydrogenated fuel are able to bring the oxygenated gas and the hydrogenated fuel to a pressure adapted to the operating pressure so that the oxygenated gas and the hydrogenated fuel are injected directly into the cell, and in that the means for discharging the gaseous effluents can discharge the gaseous effluents to outside the submarine when the submarine is diving.

The invention and its advantages will be better understood upon reading the following description, provided solely as an example, and done in reference to the appended drawings, in which:

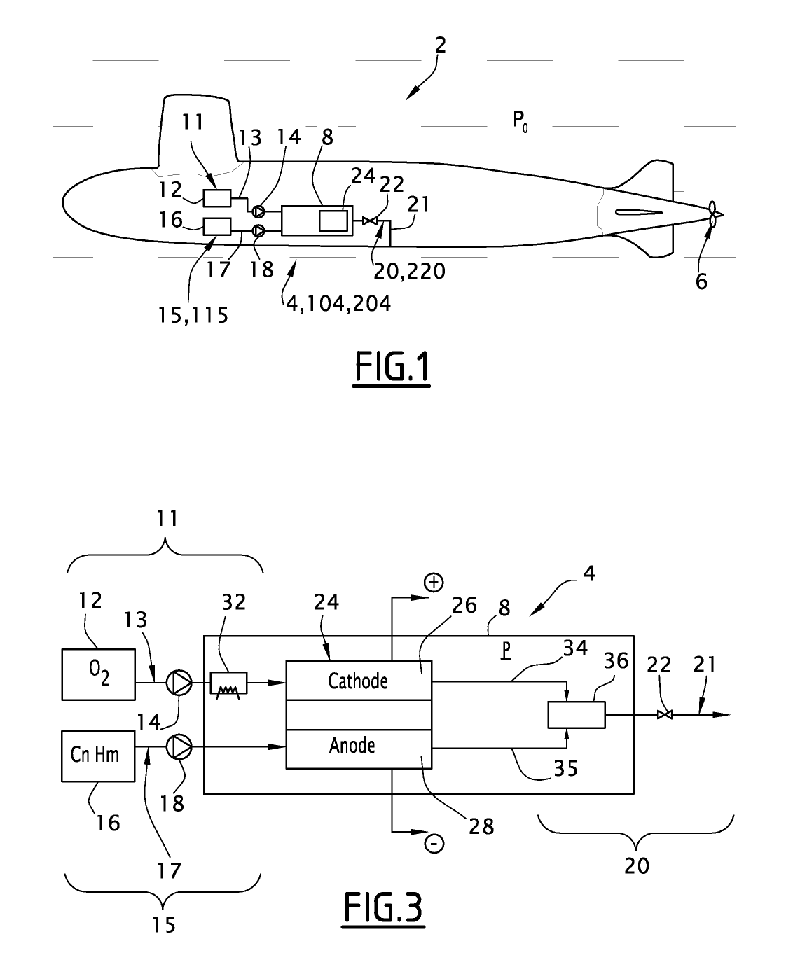

FIG. 1 is a diagrammatic illustration of a submarine according to the invention;

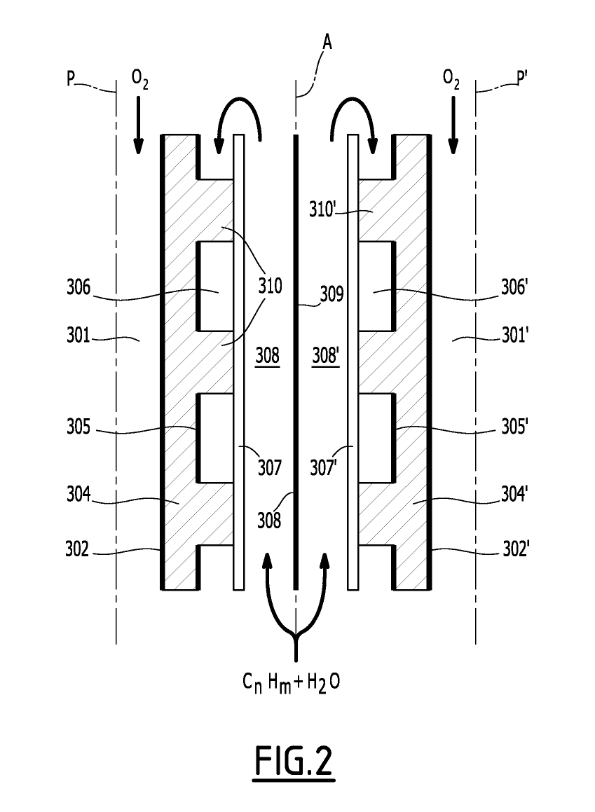

FIG. 2 diagrammatically illustrates one embodiment of an internal reforming cell implemented in the electricity production device of FIG. 1;

FIG. 3 shows an electricity production device of FIG. 1;

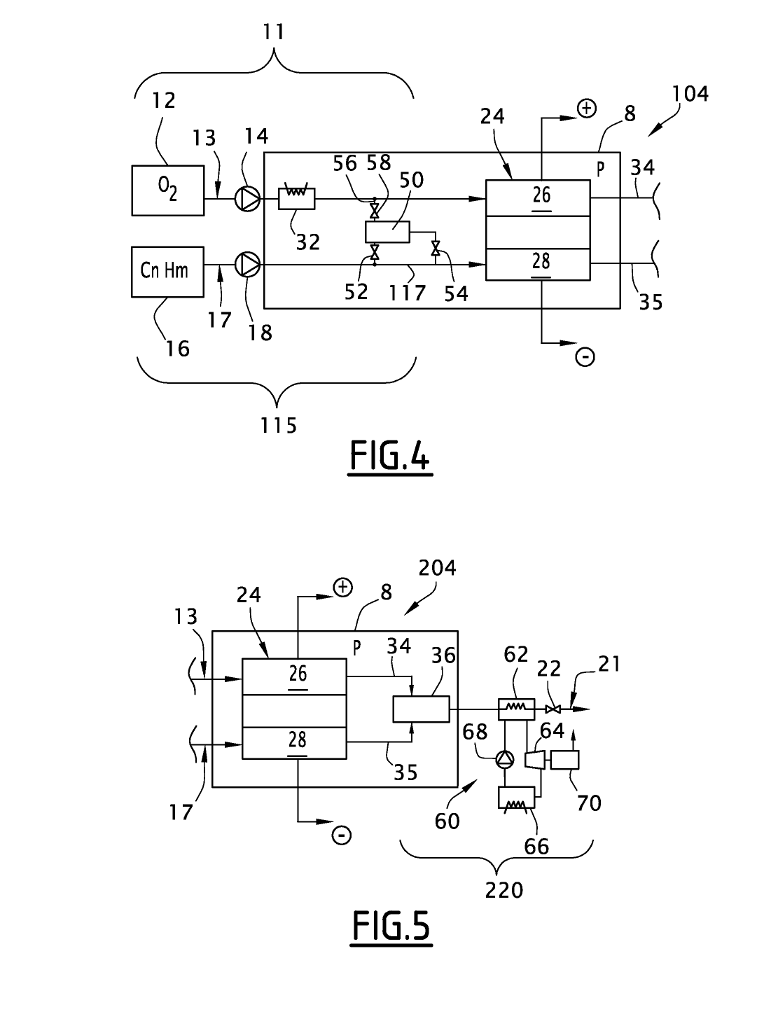

FIG. 4 shows an alternative embodiment of the electricity production device of FIG. 1; and

FIG. 5 shows an alternative embodiment of the electricity production device of FIG. 1.

FIG. 1 diagrammatically illustrates a submarine 2 equipped with an electricity production device 4 able to provide electrical power. Preferably, the electricity production device 4 in particular feeds a motor (not shown) for driving the propulsion means 6 of the submarine 2 and generates sufficient power to drive these propulsion means 6.

The electricity production device 4 includes a cell 24 that is an internal reforming fuel cell operating at a high temperature and a high pressure.

The operating temperature of the cell is between 800° and 1000° C., and preferably in the vicinity of 950° C.

The operating pressure P of the fuel cell is greater than or equal to the immersion pressure P₀ exerted by the seawater on the hull of the submarine and that depends on the depth at which the submarine is submerged. The submarine 2 is designed to resist submersion pressures P₀ lower than or equal to a maximum immersion pressure P₀ₘₐₓ. The operating pressure P of the fuel cell is preferably greater than the maximum immersion pressure P₀ₘₐₓ, and, in any case, greater than 10 bars.

In the embodiment currently considered shown in FIG. 2, the cell 24 includes a periodic stack of substantially flat cells.

FIG. 2 shows a period of that stack, situated between two planes P and P′. This period includes, on either side of a plane A of symmetry, oxygen circulation cells 301, 301′, cathodes 302, 302′, electrolyte membranes 304, 304′, anodes 305, 305′, reformate circulation cells 306, 306′, separating walls 307, 307′, hydrogenated fuel circulation cells 308, 308′, and a middle catalysis wall 309.

The electrolyte membrane 304, 304′, respectively, is a porous membrane separating the cathode from the anode 28 while allowing the ion exchange between the latter.

The middle catalysis wall 309 is a material adapted to favor reforming. That material is, for example, Nickel.

The hydrogenated fuel and steam mixture is injected directly in the circulation cells 308 and 308′ situated between the two separating walls 307 and 307′ and circulates along the middle catalysis wall 309. The temperature and pressure conditions are such that a steam reforming reaction takes place.

The steam reforming (SMR), which is the reforming reaction having the best conversion yield, is a catalytic endothermic reaction produced by the hydrogen by reaction of a hydrocarbon with water. For example, if the hydrocarbon is methane, the reaction is as follows:

CH₄+H₂O→CO+3H₂

The products of this reforming reaction, or reformates, are set in motion by convection and circulate in the cell 24. They reach the reformate circulation cells 306 and 306′.

Redox reactions then occur that generate heat and an electric current available between each anode/cathode pair 302-305 and 302′-305′.

The surface of the electrolyte membrane 304, 304′, respectively, oriented toward the middle catalysis wall 309 is provided with protrusions 310, 310′, respectively, coming into contact with the opposite separating wall 307, 307′ respectively. These protrusions form thermal bridges that transfer heat from the redox reactions toward the circulation cells of the hydrogenated fuel 308, 308′ so that the heat produced by the redox reactions contributes the heat necessary to maintain the reforming reactions, which are endothermic reactions.

It should be noted that the reforming and redox reactions occur at similar temperatures.

The internal reforming cell thus has the advantage of optimizing the management of the thermal fluxes. In particular, for steady state operation, there is no longer any need for an additional heating means of the reforming reactor, such as a burner consuming oxygen.

The internal reforming cell also has the advantage of allowing the elimination of the reforming and purifying means, which, in the prior art, are situated upstream of and outside the cell. The device implementing an internal reforming cell is consequently more compact.

In reference again to FIG. 1, the electricity production device 4 includes an enclosure 8 inside which the cell 24 is installed. The enclosure 8 is pressure-resistant and is kept at an internal pressure equal to the operating pressure P of the cell 24. This arrangement makes it possible to confine the cell 24 and increase the security of the electricity production device onboard a submarine.

Upstream of the fuel cell, the electricity production device 4 includes means for feeding oxygenated gas, indicated generally by reference 11, and means for feeding hydrogenated fuel, indicated generally by reference 15.

Downstream of the enclosure 8, the electricity production device 4 includes means for discharging the effluents produced by the fuel cell, indicated generally by reference 20. The means for discharging the effluents 20 make it possible to reject the byproducts of the chemical reactions that occur in the cell 24, to outside the submarine 2, directly in the sea, at any time during diving. In this way, it is not necessary to provide means for storing effluents inside the submarine, unlike the devices of the prior art.

That is why the fuel cell must have an operating pressure greater than the diving pressure of the submarine so as to produce effluents at a pressure higher than the pressure of the water outside the submarine, without it being necessary to increase the pressure of said effluents using, for example, a compressor.

FIG. 3 is a detailed illustration of an electricity production device 4 according to the invention.

That figure diagrammatically shows the cell 24, installed in the pressure-resistant enclosure, while showing a cathode 26, forming the positive pole of an electrical current generator, an anode 28, forming the negative pole of the electrical current generator.

Upstream of the cell 24, the means for feeding oxygenated gas 11 comprise a tank 12 that can contain liquid oxygen and a circuit 13 connecting the tank 12 to the cathode 26 of the cell 24. The circuit 13 is provided with a pump 14 and a sprayer 32, arranged serially. The pump 14 increases the pressure of the liquid oxygen brought from the tank 12 to introduce it into the sprayer 32 where a pressure reigns equal to the operating pressure P of the fuel cell 24. The sprayer 32 makes it possible, by transferring it an adapted quantity of heat, to spray the liquid oxygen introduced by the pump 14, so as to feed the cathode 26 with gaseous oxygen.

The liquid oxygen used is dioxide O₂, and preferably pure dioxide.

The supply of the fuel cell from a liquid oxygen tank via a pump that introduces liquid oxygen at a high pressure into the sprayer has the advantage of consuming less energy than pumping on a gas at ordinary pressure, with the aim of raising the pressure of the oxygen to the pressure reigning inside the enclosure.

Upstream of the fuel cell 24, the means for feeding hydrogenated fuel 17 comprise a hydrogenated fuel tank 16 and a circuit 17 connecting the tank 16 to the anode 28 of the fuel cell 24. The circuit 17 is provided with a pump 18 making it possible to increase the pressure of the hydrogenated fuel brought from the tank 16, to directly introduce it at the anode 28 where a pressure reigns that is equal to the operating pressure P of the fuel cell.

The hydrogenated fuel is a hydrocarbon or a mixture of hydrocarbons with generic formula CₙHₘ. or CₙHₘOₚ.

Downstream of the fuel cell 24, the means for discharging effluents 20 comprise a downstream burner 36 connected, at the input, by a first circuit 34, to the cathode 26 of the cell 24 and, by a second circuit 35, to the anode 28 of the cell 24. The downstream burner 36 is connected, at the output, by a discharge circuit 21 to a mouth situated on the hull of the submarine 2 and opening to the outside thereof. The discharge circuit 21 is provided with a pressure regulating valve 22 to be able to maintain the operating pressure of the cell 24 above the immersion pressure P₀, while controlling the flow rate of the gaseous effluents.

The operation of the electricity production device 4 of the submarine 2 will now be described.

The pump 14 of the means for supplying oxygenated gas 11 is actuated to bring a quantity of liquid oxygen from the tank 12 into the sprayer 32, where that quantity of oxygen undergoes a phase change. The gaseous oxygen is then introduced into the cathode 26.

In parallel, the pump 18 of the means for supplying hydrogenated fuel is actuated to bring a quantity of hydrogenated fuel from the tank 16, directly into the cell 24.

Inside the cell 24, a first steam reforming step of the hydrogenated fuel takes place. It is made possible by the high operating temperature in the vicinity of 950° C. During this first reaction step, the hydrogenated fuel is transformed according to the following chemical reaction:

CₘHₙ+mH₂O→mCO+(m+n/2) H₂

The obtained mixture, rich in dihydrogen, undergoes a second redox step, according to the following reactive equations:

H₂+½O₂→H₂O and CO+½O2→CO2.

Part of the water produced during the second redox step is used in the first steam reforming step. Thus, the electricity production device 4 is self-sufficient in water.

The effluents discharged from the cell 24 are introduced into the downstream burner 36. The burned effluents are extracted from the burner 36 at the operating pressure P of the fuel cell and discharged, via the pressure regulating valve 22, into the seawater outside the submarine 2 while diving.

In the device described above, the sprayer 32 and the downstream burner 36 are installed in the pressurized enclosure 8.

Alternatively, the downstream burner 36 is installed outside the enclosure 8 and/or the sprayer 32 is placed outside the enclosure 8.

To initiate the chemical reactions that must occur in the cell 24, the electricity production device must be started using a system for preheating the hydrogenated fuel. Once the cell is started, the preheating of the fuel is no longer useful. In the device presented above, the preheating system is outside the electricity production device 4. It is either on the dock, or onboard the submarine 2.

In the alternative embodiment shown in FIG. 4, the preheating system is incorporated into the electricity production device so as to give the latter operating autonomy upon startup.

According to this alternative, the means for feeding hydrogenated fuel 115 to the electricity production device 104 include an upstream burner 50 as preheating system. The upstream burner 50 is placed in parallel with a channel 117 of the circuit 17 for feeding hydrogenated fuel, between the pump 18 and the anode 28. First and second valves 52 and 54 make it possible to connect or isolate the upstream burner 50 and the channel 117. When the first and second valves 52 and 54 are open, a fraction of the flow of hydrogenated fuel brought by the pump 18 circulates in the upstream burner 50.

The upstream burner 50 is fed with fuel by a channel 56 parallel connected with the circuit for feeding oxygenated gas 13. The upstream burner 50 is placed downstream of the sprayer 32. The channel 56 includes a third valve 58 making it possible, when it is open, the feed the upstream burner 50 with oxygenated gas in gaseous form.

The upstream burner 50 is used only upon startup of the electricity production device 104 to preheat the equipment used in the chemical reactions that must occur at the fuel cell 24. Once the chemical reactions are initiated, the valves 52, 54 and 58 are closed to isolate the upstream burner 50 from the feed circuits 13 and 17. The supply of hydrogenated fuel is then done directly from the hydrogenated fuel tank 16 toward the anode 28 via the pump 18 and the channel 117.

Different alternatives can be considered for this alternative of the electricity production device. In particular, the upstream burner 50 can be installed outside the enclosure 8.

FIG. 5 shows an alternative of the electricity production device of FIG. 1. In that alternative, independent of the preceding ones, the fuel cell and its supply means are identical to either of the embodiments, but the means for discharging effluents 220 from the electricity production device 204 also comprise means for recovering thermal energy. In fact, to increase the output of the electricity production device, it is advantageous to recover a fraction of the thermal energy of the gaseous effluents, the latter having a temperature close to 950° C. at the outlet of the cell 24 and the downstream burner.

The thermal energy recovery means are made up of a secondary circuit 60. The secondary circuit 60 includes a steam generator 62, a steam turbine 64, a steam condenser 66 and a pump 68 for recirculating the fluid circulating in the secondary circuit 60.

As in the preceding embodiments, the circuit 21 for discharging the gas includes a pressure regulating valve 22 making it possible to keep the upstream pressure higher than the pressure reigning outside the submarine.

The steam generator 62 is connected to the circuit 21 for discharging the gaseous effluents, as a primary circuit supplying the heat necessary for the evaporation of the liquid from the secondary circuit 60.

As in the preceding embodiments, the gas discharge circuit 21 includes a pressure regulating valve 22 making it possible to keep the upstream pressure higher than the pressure reigning outside the submarine.

The steam turbine 64 is coupled to an alternator 70 generating additional electrical power.

The additional electrical power provided by the secondary circuit 60 can represent approximately 15% of the total electric power generated by the electricity production device 204 that has, as a result, a high global output that can go up to about 65%.

The use of a steam generator 62 makes it possible to preserve the pressure potential of the gaseous effluents, while also recovering part of their thermal energy. One thus keeps the possibility of directly discharging the gaseous effluents into the sea.

The electricity production device according to the invention provides significant electrical power. With adapted dimensioning, such an electricity production device can be made compatible with a use as electrical power source to feed the propulsion means of the submarine.

The use of a fuel cell operating at a high temperature makes it possible to perform the reforming reactions directly inside the cell. Furthermore, this cell is much less sensitive to pollutants than low-temperature cells, so that a multitude of fuels can be used for the hydrogen contribution. The use of a fuel cell operating at a high pressure makes it possible to discharge the effluents directly into the seawater.

1. A submarine including a device for producing electricity (4, 104, 204) comprising a fuel cell, means for feeding oxygenated gas, means for feeding hydrogenated fuel, and means for discharging the gaseous effluents, characterized in that the fuel cell (24) is an internal reforming cell operating at a high temperature and a high pressure, the operating pressure (P) of the cell being greater than or equal to an immersion pressure (P₀) of the submarine (2),
in that the means for feeding oxygenated gas (11) and the means for feeding hydrogenated fuel (15, 115) are capable of bringing the oxygenated gas and the hydrogenated fuel to a pressure adapted to the operating pressure so that the oxygenated gas and the hydrogenated fuel are injected directly into the cell,
and in that the means for discharging the gaseous effluents (20, 220) are capable of discharging the gaseous effluents outside the submarine during diving.

2. The submarine according to claim 1, characterized in that the means for discharging the gaseous effluents (20, 220) include a circuit (21) for discharging the gaseous effluents provided with a pressure regulating valve (22) making it possible to keep the operating pressure (P) above the immersion pressure (P₀).

3. The submarine according to claim 2, characterized in that the means for discharging the gaseous effluents (20, 220) also include a downstream burner (36) connected at the input, on the one hand, to a cathode (26) of the fuel cell (24) and, on the other hand, to an anode (28) of the fuel cell (24), and connected at the output to the pressure regulating valve (22).

4. The submarine according to claim 3, characterized in that the means for discharging the gaseous effluents (220) also include a device for recovering the thermal energy of the gaseous effluents.

5. The submarine according to claim 4, characterized in that the device for recovering the thermal energy from the gaseous effluents is a secondary circuit (60) including a steam generator (62), a steam turbine (64) coupled to an alternator (70), a steam condenser (66) and a recirculation pump (68), the steam generator being coupled to the circuit for discharging the gaseous effluents (21).

6. The submarine according to claim 1, characterized in that the means for feeding oxygenated gas (11) include an oxygen tank (12) that can contain pure oxygen in liquid phase.

7. The submarine according to claim 6, characterized in that the means for feeding oxygenated gas (11) include a sprayer (32) able to generate gaseous oxygen to feed the fuel cell (24), and a pump (14) able to introduce liquid oxygen into the sprayer at a pressure adapted to the operating pressure (P).

8. The submarine according to claim 1, characterized in that the means for feeding hydrogenated fuel (15, 115) include a hydrocarbon tank (16) and a pump (18) that can introduce hydrogenated fuel into the fuel cell (24) at the operating pressure (P).

9. The submarine according to claim 8, characterized in that the means for feeding hydrogenated fuel (115) also comprise an upstream burner (50) connected between the pump (18) and the fuel cell (24), the upstream burner (50) being supplied with fuel by a bridge of the means for feeding oxygenated gas (11), the upstream burner (50) constituting a system for preheating the hydrogenated fuel.

10. The submarine according to claim 1, characterized in that at least the fuel cell (24) is installed in a pressure-resistant enclosure (8) whereof the internal pressure is kept at the operating pressure (P) of the fuel cell.

11. The submarine according to claim 1, characterized in that the operating pressure (P) of the fuel cell (24) is greater than or equal to 10 bars, and preferably greater than or equal to a maximum immersion pressure (P₀ₘₐₓ) of the submarine (2).

12. A device for producing electricity for a submarine, of the type including a fuel cell (24), means for feeding oxygenated gas (11), means for feeding hydrogenated fuel (15, 115) and means for discharging gaseous effluents (20, 220), characterized in that the fuel cell (24) is an internal reforming cell operating at a high temperature and a high pressure, the operating pressure (P) of the cell being greater than or equal to an immersion pressure (P₀) of the submarine (2),
in that the means for feeding oxygenated gas (11) and the means for feeding hydrogenated fuel (15, 115) are able to bring the oxygenated gas and the hydrogenated fuel to a pressure adapted to the operating pressure so that the oxygenated gas and the hydrogenated fuel are injected directly into the cell,
and in that the means for discharging the gaseous effluents (20, 220) can discharge the gaseous effluents to outside the submarine when the submarine is diving, without causing the pressure in the fuel cell to drop.

13. The submarine according to claim 2, characterized in that the means for discharging the gaseous effluents (220) also include a device for recovering the thermal energy of the gaseous effluents.

14. The submarine according to claim 13, characterized in that the device for recovering the thermal energy from the gaseous effluents is a secondary circuit (60) including a steam generator (62), a steam turbine (64) coupled to an alternator (70), a steam condenser (66) and a recirculation pump (68), the steam generator being coupled to the circuit for discharging the gaseous effluents (21).
